(19) United States
(12) Patent Application Publication
(10) Pub. No.: US 2002/0158775 A1
(43) Pub. Date: Oct. 31, 2002

(54) Telemetry system and method for home-based diagnostic and monitoring devices

(76) Inventor: David A. Wallace, Westwood, CA (US)

Correspondence Address: LYON & LYON LLP, 633 WEST FIFTH STREET, SUITE 4700, LOS ANGELES, CA, 90071, US

(21) Appl. No.: 09/844,419

(22) Filed: Apr. 27, 2001

(51) Int. Cl. H04Q 9/00; G08C 19/22

(52) U.S. Cl. 340/870.07

(57) ABSTRACT

Telemetry systems and methods are provided for transferring data between sensor devices and a base station using a local carrier media network, such as AC power lines. A relay module receives sensor data from a sensor, e.g., monitoring a health-related parameter of a patient. The relay module is connected to the local carrier media network and generates carrier media signals including sensor data and an identifier identifying the sensor device and/or the patient. A base station is connected to the local carrier media network for detecting carrier media signals from one or more relay modules. The base station extracts sensor data and associated identifiers from detected carrier media signals. The base station is connected to an electronic network, e.g., the Internet, for transferring sensor data and associated identifiers over the network to a remote server computer for inclusion in a patient database.

### FIELD OF THE INVENTION

The present invention relates generally to telemetry systems and methods for transferring data between input devices and a base station locally using carrier media, and more particularly to systems and methods for transferring data from medical diagnostic or monitoring devices using carrier media to a base station for storage and/or transmission to another location, e.g., via an electronic network to a remote server computer.

### BACKGROUND

Traditionally, health care professionals have diagnosed and treated patients within the context of a medical office, clinic, hospital, outpatient center, or other health care facility. Patients may receive medical tests, treatment, or other specialized care, e.g., using equipment appropriate for such care. More recently, certain diagnostic tests and studies may now be automated and performed using relatively low-cost, stand-alone devices. These devices have created opportunities for monitoring medical parameters or conditions outside of a health care facility, i.e., at a remote location, such as a patient's home.

For example, devices are now available for measuring and/or monitoring various health-related indices, such as blood pressure, blood glucose levels, arterial blood gases (e.g., oxygen or carbon dioxide), urine protein content, urine sugar content, and the like. In addition, electronic devices are now widely available for monitoring and/or recording electrocardiographic information, such as Holter monitors, pacemakers, defibrillators, and the like, that may be attached to or implanted within a patient.

These devices, however, may require a patient to use the device, manually record data, and then transfer the data to their health care professional, e.g., by calling their doctor's office by telephone. Other devices may automatically record data, but may require the patient to transfer the recorded data to their health care professional. This may result in inaccuracies in the data transferred and/or omissions, for example, if the patient forgets to transfer the data.

Accordingly, systems and methods that facilitate storage and/or transfer of medical data, e.g., via an electronic network, would be considered useful.

### SUMMARY OF THE INVENTION

The present invention is directed to telemetry systems and methods for transferring data between sensor devices and a base station locally using carrier media. The systems and methods may be applied within a health-care facility (e.g., physician's office, clinical laboratory, hospital, and the like), as well as outside the context of a health-care facility, e.g., within a patient's home. More particularly, systems and methods in accordance with the present invention may facilitate transfer of data from portable medical diagnostic, monitoring, or other sensor devices that patients or other individuals may use themselves, e.g., at home or elsewhere. The sensor devices generally use carrier media, such as local alternating current power lines, to communicate data to a base station for storage and/or subsequent transmission to a remote location, e.g., via an electronic network to a remote server computer.

In accordance with one aspect of the present invention, a system is provided for transferring sensor data via an electronic network to a remote location that includes a sensor device for generating sensor data related to a human subject, a relay module, and a base station.

The relay module is operatively connected to the sensor device for receiving sensor data from the sensor device, and is connectable to a local carrier media network. The sensor device and the relay module may be directly connected or may include a transmitter and receiver, e.g., using a carrier media, such as infrared or radio frequency (RF) signals, for transmitting the sensor data from the sensor device to the relay module. The relay module includes a coupler for sending a carrier media signal over the local carrier media network, the carrier media signal including the sensor data. Preferably, the carrier media signal is an alternating current power supply signal that carries a relatively high frequency modulated signal that includes the sensor data. More preferably, the relatively high frequency signal is a radio frequency (RF) signal, such as a spread spectrum signal.

The base station is also connectable to the local carrier media network, and is configured for detecting carrier media signals, such as the carrier media signal from the relay module. The base station includes a decoupler for extracting the sensor data from the carrier media signal. The base station also includes an interface connectable to the electronic network, e.g., a modem for transferring the sensor data over the electronic network to a remote location.

In accordance with another aspect of the present invention, a system for monitoring one or more patients is provided that includes a plurality of sensor devices for monitoring health-related parameters of one or more patients, the sensor devices generating sensor data quantifying respective health-related parameters.

A relay module receives sensor data from a respective sensor device, the relay module configured for generating a carrier media signal including the sensor data and a sensor identifier identifying the respective sensor device. The relay module also includes a coupler connectable to a local carrier media network for sending the carrier media signal over the local carrier media network.

A base station is connectable to the local carrier media network, the base station configured for detecting carrier media signals from one or more relay modules. The base station includes a decoupler for extracting sensor identifiers and associated sensor data from detected carrier media signals. The base station may include memory for storing sensor identifiers and associated sensor data received from respective relay modules. In addition, the base station may include an interface connectable to an electronic network, the interface configured for communicating sensor data via the network to a remote location.

In accordance with yet another aspect of the present invention, a method is provided for transferring sensor data from a sensor device to a remote location. Sensor data is acquired with the sensor device, and a carrier media signal is generated, the carrier media signal including the sensor data. The carrier media signal is sent over a local carrier media network, such as alternating current power lines, and is detected by a base station connected to the local carrier media network. The sensor data is extracted from the carrier media signal, and transmitted over an electronic network to a remote location, such as a central server computer.

Other objects and features of the present invention will become apparent from consideration of the following description taken in conjunction with the accompanying drawings.

### BRIEF DESCRIPTION OF THE DRAWINGS

FIG. 1 is a block diagram of a preferred embodiment of a telemetry system, in accordance with the present invention.

FIG. 2 is a block diagram of a sensor device for use in a telemetry system, such as that shown in FIG. 1.

FIG. 3 is a block diagram of a relay module for use in a telemetry system, such as that shown in FIG. 1.

FIG. 4 is a block diagram of a base station for use in a telemetry system, such as that shown in FIG. 1.

FIG. 5 is a block diagram, showing a preferred configuration of data transferred using a telemetry system, in accordance with the present invention.

FIG. 6 is a flowchart, showing a preferred method for transferring sensor data, in accordance with the present invention.

FIG. 7 is a block diagram of another preferred embodiment of a telemetry system, in accordance with the present invention.

FIG. 8 is a block diagram of a preferred embodiment of a set of telemetry systems connectable to a server computer for generating a database of patient data, in accordance with the present invention.

### DETAILED DESCRIPTION OF THE PREFERRED EMBODIMENTS

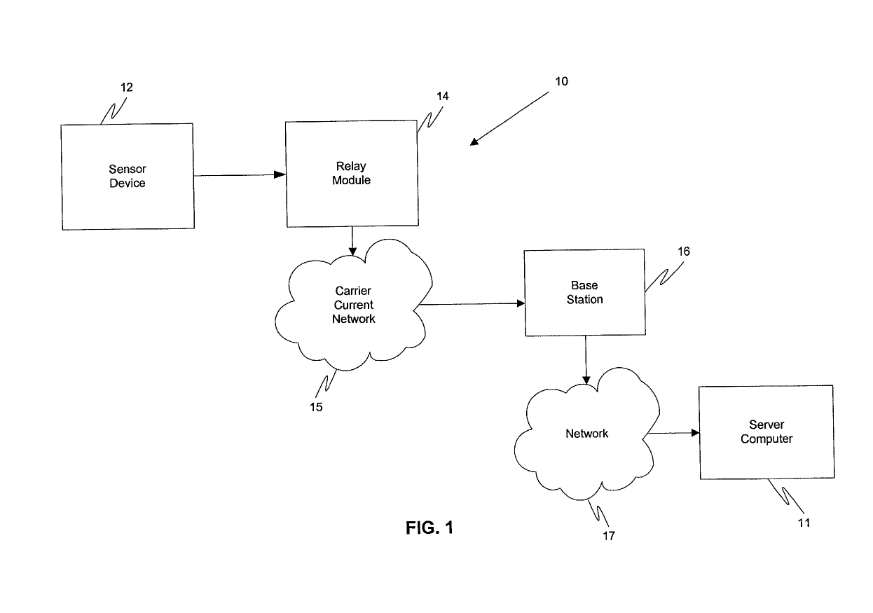

Turning now to the drawings, FIGS. 1-4 show a first preferred embodiment of a telemetry system 10, in accordance with the present invention. The system 10 generally includes a sensor device 12, a relay module 14, and a base station 16. The sensor device 12 is operatively coupled to the relay module 14. The relay module 14, in turn, is connected via a local carrier media network 15 to the base station 16. The base station 16 is connected both to the local carrier media network 15 and to an electronic network 17, such as a telecommunications network, preferably the Internet.

The sensor device 12 may be any of a variety of medical monitoring devices, e.g., for detecting, measuring, analyzing, or otherwise monitoring a health-related parameter. For example, the sensor device 12 may be a portable device, e.g., for directly measuring a physiological parameter of a user, such as blood pressure, heart rate, blood gas (e.g., oxygen, carbon dioxide) content, intraocular pressure, electrocardiographic parameters, and the like. Alternatively, the sensor device 12 may measure properties of specimens provided by the user, such as urine protein content, urine sugar content, blood glucose content, and the like. In other embodiments, the sensor device 12 may be an implanted device or one that is attached to the user, such as a pacemaker, a defibrillator, and the like.

In yet another embodiment, the sensor device 12 may monitor behavioral aspects of the user, possibly medically related or merely personal behavior. For example, the sensor device 12 may be connected to a television, cable box, video cassette recorder, or other audio visual device (not shown) for monitoring a user's television viewing habits.

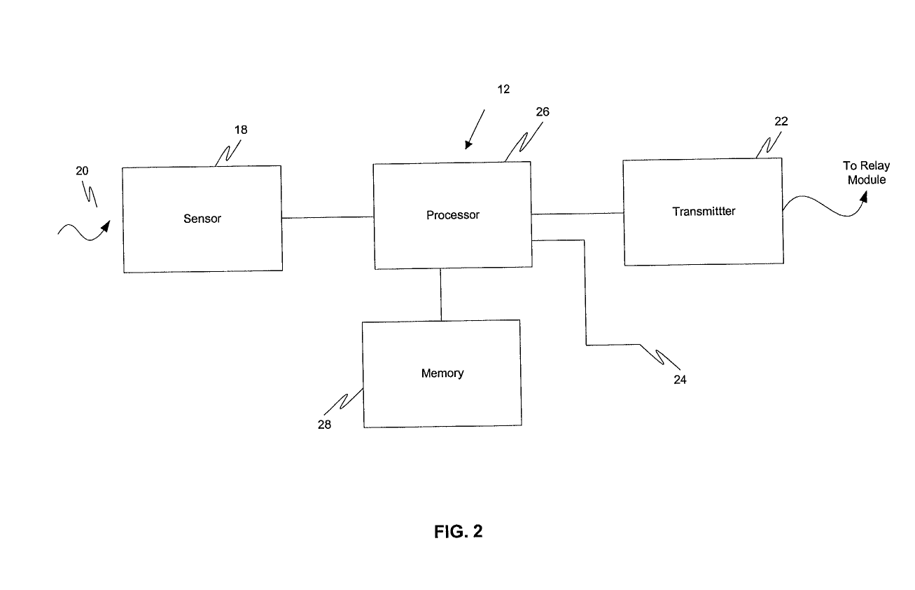

With particular reference to FIG. 2, the sensor device 12 preferably includes a sensor 18 for producing sensor data based upon a desired input 20, such as a physiological or behavior parameter, a specimen, and the like. The sensor 18 may be permanently connected to the sensor device 12 or may be detachable and/or replaceable. If the sensor 18 is implanted within a patient, a connector may be provided, e.g., on the surface of the patient's skin, to connect internal components, e.g., the sensor 18 itself, to external components of the sensor device 12. Alternatively, the sensor device 12 may include an RF transmitter (not shown) or other device for transmitting data from the implanted sensor device 12 to the relay module 14.

The sensor device 12 is preferably coupled to the relay module 14 (not shown in FIG. 2) by a transmitter 22 for wirelessly transmitting sensor data to the relay module 14. The transmitter 22 may include a radio frequency (RF) transmitter, an infrared transmitter, or other wireless transmitter. In a preferred embodiment, the transmitter 22 is a short-range RF transmitter configured for transmitting single frequency or spread spectrum signals. Alternatively, or in addition, the sensor device 12 may be connectable directly to the relay module 14, e.g., via a port 24 to which a cable or other connector (not shown) may be connected between the sensor device 12 and the relay module 14.

In addition, the sensor device 12 may include a processor 26 coupled to the sensor 18 and/or the transmitter 22. The processor 26 may be configured for controlling the sensor 18 and/or the transmitter 22, e.g., to selectively, periodically, and/or automatically activate the sensor 18 to obtain sensor data and/or to transmit sensor data via the transmitter 22. In addition, the sensor device 12 may include a user interface, e.g., a keyboard, keypad, set of buttons, dials, or other input device (not shown), and/or a display or other output device (also not shown). The sensor device 12 may also include memory 28 for storing sensor data, e.g., until the sensor data is transmitted to the relay module 14. Exemplary embodiments of a sensor device 12 may include a blood sugar monitor (for diabetics), a tonometer (for detecting glaucoma), and the like.

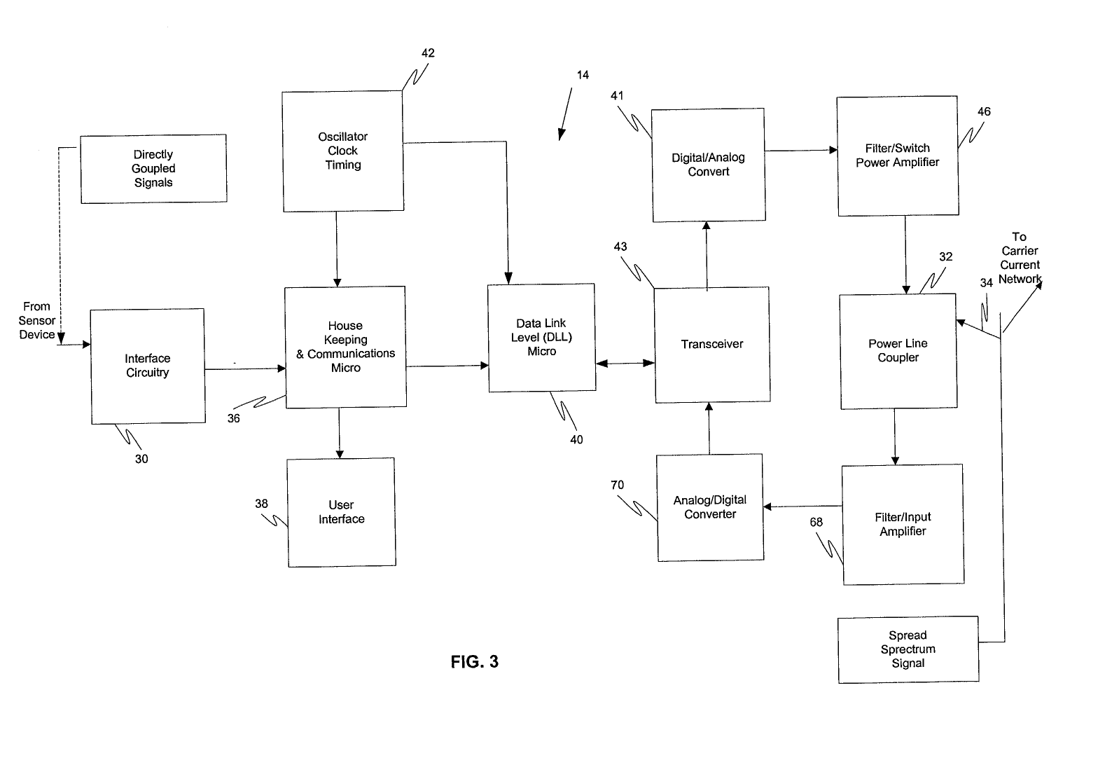

Turning to FIG. 3, the relay module 14 generally includes an interface 30 for receiving sensor data from the sensor device 12. For example, the interface 30 may be a receiver, e.g., an infrared or RF receiver, corresponding to the transmitter 22 in the sensor device 12. Preferably, the interface 30 is a short-range RF receiver that may receive single frequency or spread spectrum signals from the sensor device 12. Alternatively, the relay module 14 and sensor device 12 may be directly connected to one another, e.g., by one or more cables. In a further alternative, the relay module 14 may be provided within the sensor device 12, e.g., as separate hardware components and/or software modules.

The relay module 14 also generally includes a coupler 32 for sending a carrier media signal 34 including the sensor data therein. To prepare the sensor data received from the sensor device 12 for transmission, the relay module 14 may include one or more processors and/or other components. Although separate components are shown schematically in FIG. 3, it will be appreciated that the operations performed by the relay module 14 may be completed using one or more hardware components and/or software modules.

For example, the relay module 14 may include a processor 36 for controlling its general operation. The processor 36 may receive instructions from the user via an interface 38, such as a keyboard, keypad, computer mouse, and the like. These instructions may include activating or deactivating the relay module 14 to receive sensor data from the sensor device 12 and/or to send the carrier media signal 34, to manually add information to the sensor data, and the like.

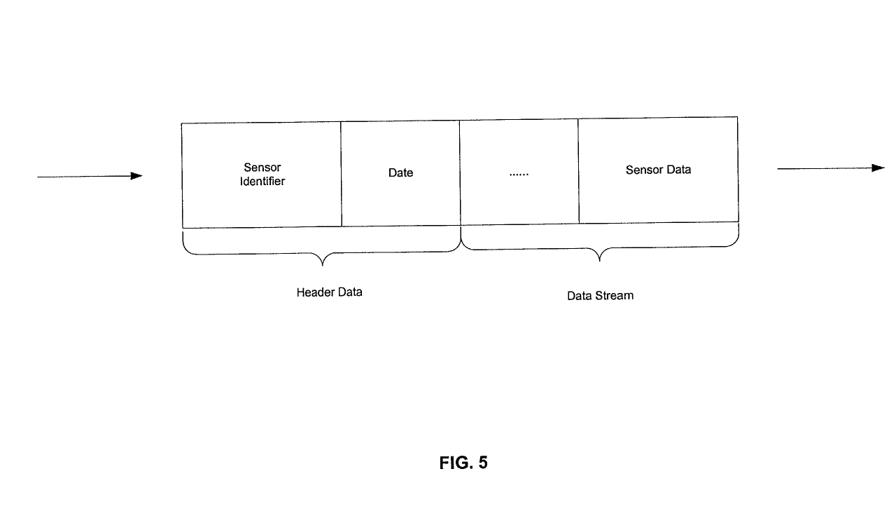

The relay module 14 may also include a processor 40 for associating additional data with the sensor data. For example, the relay module 14 may include a clock 42, and the processor 40 may automatically assign a date and/or time stamp to the sensor data when it is received from the sensor device 12. Alternatively, one or more of these components, such as the interfaces 30, 38 and processors 36, 40 may be combined into a single microprocessor or microcomputer (not shown). Alternatively or in addition, the processor 40 may add a sensor identifier to the sensor data, thereby associating the sensor data with a specific sensor device. The sensor identifier may include a serial number for the sensor device, may identify the type of sensor device, may identify the patient, and the like. FIG. 5 shows an exemplary string of data that may be generated by the processor 40 including header data followed by a data stream. The header data may include any of the information described above, and preferably includes one or more of the following:

a) a device code or designation, identifying the sensor device by its type (e.g., “a tonometer”);

b) a notice identifying the length of the header data and/or the data stream;

c) a serial number or other identifier uniquely identifying the sensor device;

d) a patient identifier identifying the individual patient or associating the sensor device with a particular user;

e) a sensor identifier, e.g., serial number, identifying the specific sensor device;

f) date and/or time stamp; and/or

g) a confirmation indicating receipt of the sensor data from the sensor device and/or the relay module.

In addition, the string of data may include a start bit, sensor data, an end bit, a parity bit and/or other error-checking segment. Alternatively, a portion or all of the header data may be repeated, for error detection. In a further alternative, an error-checking segment may be included in the header data. Further, the header data or the sensor data may include a message field, e.g., that may include an alarm indicator, may indicate a priority or urgency of the sensor data included in the string of data.

The relay module 14 may also include a transceiver 43, a digital-to-analog converter 41, and/or a filter/switch/power amplifier 46 that may prepare sensor data for transfer. These components may generate a data signal including the sensor data and any associated header data that may be carried by a carrier media. Preferably, the data signal is a relatively high frequency signal (as compared to the carrier media, which may be only sixty Hertz alternating current (60 Hz AC)), such as a radio frequency (RF) signal. More preferably, the data signal is a spread spectrum signal that may be carried by a carrier media.

The coupler 32 may use conventional methods to add the data signal to the carrier media. For example, the coupler 32 may modulate the carrier media to include the data signal, thereby including the sensor data in the carrier media signal 34 that may be transmitted over a local carrier media network 15 (shown in FIG. 1), such as household electrical power wiring. The relay module 14 may include an output connector coupled to the coupler 32, such as a conventional electrical plug (not shown), that may be plugged into an existing electrical outlet (also not shown), thereby enabling the carrier media signal 34 to be transmitted via wiring (also not shown) connected to the electrical outlet. Alternatively, the relay module 14 may be configured for transmitting using other local carrier media networks, such as local telephonic wiring, and the like. In a further alternative, the relay module 14 may transmit using wireless communications, e.g., including a radio frequency or infra-red transmitter (not shown).

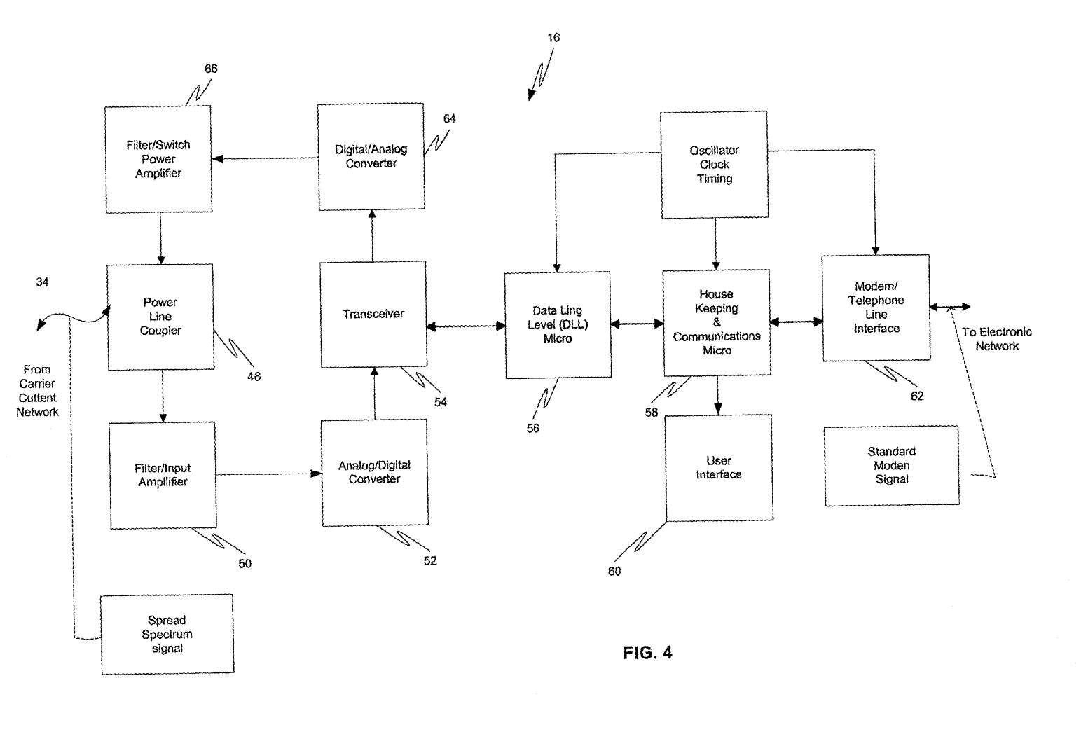

Turning to FIG. 4, the base station 16 is connectable to the local carrier media network 15 (shown in FIG. 1) and is generally configured for detecting carrier media signals 34 from one or more relay modules (not shown). The base station 16 may be a stand-alone device or may be one or more hardware components, e.g., cards, that may be installed within another computing device, such as a personal computer at the user's home.

The base station 16 generally includes a coupler 48 for extracting data signals, including sensor identifiers and associated sensor data, from detected carrier media signals 34. As is known in the art, the coupler 48 may capacitatively separate the carrier media signal 34 to isolate data signals from the carrier media.

Similar to the relay module 14, the base station 16 may include a filter/input amplifier 50, an analog-to-digital converter 52, and/or a transceiver 54 for extracting sensor data and header data from the data signals provided by the coupler 48. The base station 16 may also include one or more processors 56, 58 for controlling its operation and/or processing the sensor data, as required. For example, memory (not shown) may be coupled to the processors 56, 58 for storing sensor data in a predetermined manner, e.g., based upon sensors associated with respective sensor identifiers included in header data along with the associated sensor data received from respective relay modules. The base station 16 may also include a user interface 60, such as a keyboard, mouse, or other input device and/or a display or other output device (not shown), for allowing a user to communicate and/or control the base station 16.

In addition, the base station 16 preferably includes an interface 62 connectable to an electronic network, such as a conventional modem. Preferably, the interface 62 is configured for communicating data via the network to a remote location, such as over the Internet to a server computer, which may be accessed by the user's doctor or other health care professionals.

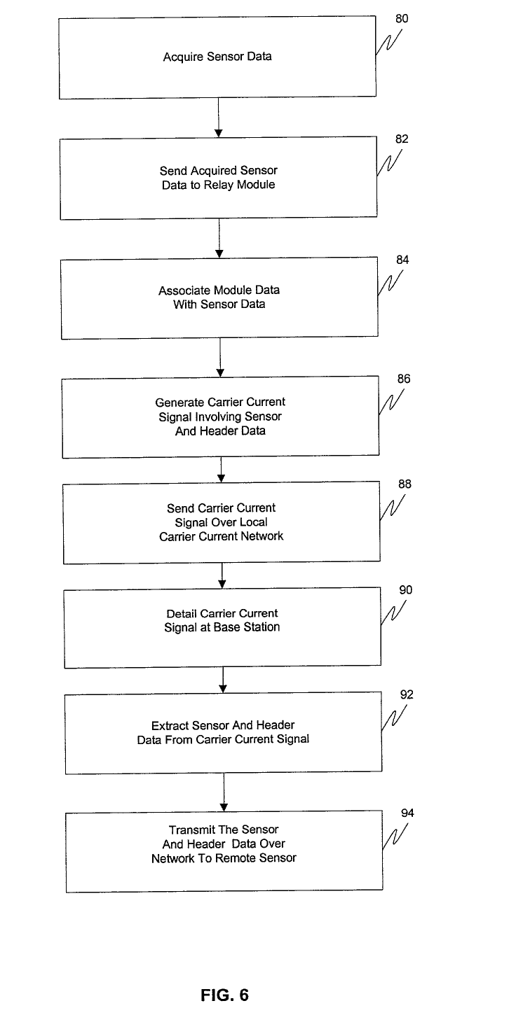

Turning to FIGS. 1 and 6, the use of a system 10, according to the present invention, may proceed as follows. First, the system 10 may be set up at a physical site, such as a patient's home, including a local carrier media network 15, such as a network of alternating current power lines. The base station 16 may be connected to the local carrier media network 15, e.g., by plugging a cable coupled to a coupler (not shown) of the base station 16 into an electrical outlet. The base station 16 may also be connected to an electronic network 17, such as the Internet, by plugging a cable coupled to a modem (not shown) of the base station 16 into a telephone jack, cable jack, or other junction communicating with a common carrier network (not shown).

The relay module 14 may then be placed at any location at the patient's home having access to the local carrier media network 15, for example, in a different room than the base station 16. The relay module 14 may then be connected to the local carrier media network 15, e.g., by plugging a cable coupled to a coupler (not shown) of the relay module 14 into an electrical outlet at the location. Thus, the relay module 14 may be placed at any convenient location, such as on a bathroom counter, that may not be able to accommodate a larger device, such as the base station 16, and/or may not provide access to a telephone line or other electronic network connection.

A sensor device 12 may then be provided, e.g., connected to the relay module 14. Preferably, the sensor device 12 and relay module 14 communicate using wireless transmissions, e.g., having relatively low power. Thus, the sensor device 12 may remain substantially portable yet remain in relative close proximity to the relay station 14, preferably within the same room. Alternatively, they may communicate via hard wire connections or may be contained in a single device. The system 10 is then ready to acquire and transfer data.

With particular reference to FIG. 6, at step 80, sensor data is acquired with the sensor device 12. For example, the user may place the sensor device 12 in contact with their anatomy to measure a physiological parameter, or the user may place a specimen in the sensor device 12 to obtain a property measurement of the specimen. Alternatively, the sensor device 12 may be implanted within the user's body, requiring the user to connect the sensor device 12 to a transmitter (not shown) or directly to the relay module 14 in order to acquire sensor data. The sensor device 12 may be selectively activated by the user or may automatically activate and acquire sensor data, either for immediate transfer or for storage and subsequent transfer.

At step 82, the sensor data acquired by the sensor device 12 is sent from the sensor device 12 to the relay module 14. This may involve wireless transmission, for example, of a radio frequency (RF) signal, between the sensor device 12 and the relay module 14. Alternatively, the relay module 14 and the sensor device 12 may be contained in a single device, as described above. If desired, at step 84, header data may be associated with the sensor data, as described above. For example, a sensor identifier identifying the sensor device, a date and/or time stamp, a patient identifier identifying the user, and the like may be added to the sensor data.

At step 86, the relay module 14 may generate a carrier media signal, the carrier media signal including the sensor data. Preferably, as described above, the carrier media signal is a carrier media that is modulated to include a relatively high frequency data signal representing the sensor data and header data.

At step 88, the carrier media signal may then be sent by the relay module 14 over the local carrier media network 15. Alternatively, the relay module 14 may store the sensor data, and periodically send a carrier media signal including the data signal over the local carrier media network 15.

At step 90, the carrier media signal may be detected at the base station 16 connected to the local carrier media network 15. The base station 16 may then extract the data signal from the carrier media signal, and retrieve the sensor data and header data from the data signal. The base station 16 may then store the data locally or immediately prepare the data for transmission. If multiple relay modules (not shown) are connected to a single local carrier media network 15, the base station 16 may detect and identify individual relay modules and their associated sensor devices based upon header data in detected carrier media signals. Thus, the base station 16 may selectively ignore and/or receive data from individual sensor devices.

At step 90, the base station 16 may then transmit the sensor data and header data over an electronic network 17 to a remote location, e.g., at predetermined intervals. The base station 16 may initiate a telephone call directly to a remote server computer 11 or otherwise contact the server computer 11 via the Internet. The base station 16 and server computer 11 may exchange a “handshake,” e.g., for security purposes to preclude unauthorized access. In addition, or alternatively, the handshake may confirm accuracy of data, i.e., perform error-checking, and allow data to be retransmitted to correct for detected errors. The base station 16 may then send the sensor data and header data, which may be compiled into a database of patient information. Preferably, the base station 16 is pre-programmed to transfer data to the server computer 11 at predetermined intervals, e.g., every twenty four hours. With each transfer, the transferred data is added to the database, which may then be accessed by a doctor or other health care professional to monitor the patient's condition and/or progress. Alternatively, or in addition, the server computer 11 may automatically monitor the transferred data, e.g., to look for a predetermined condition, e.g., an absolute data value and/or a predetermined change, that may require action. The server computer 11 may even automatically initiate contact with an identified health care professional when the predetermined condition is detected. Immediate response may then be taken to ensure that the patient receives proper care.

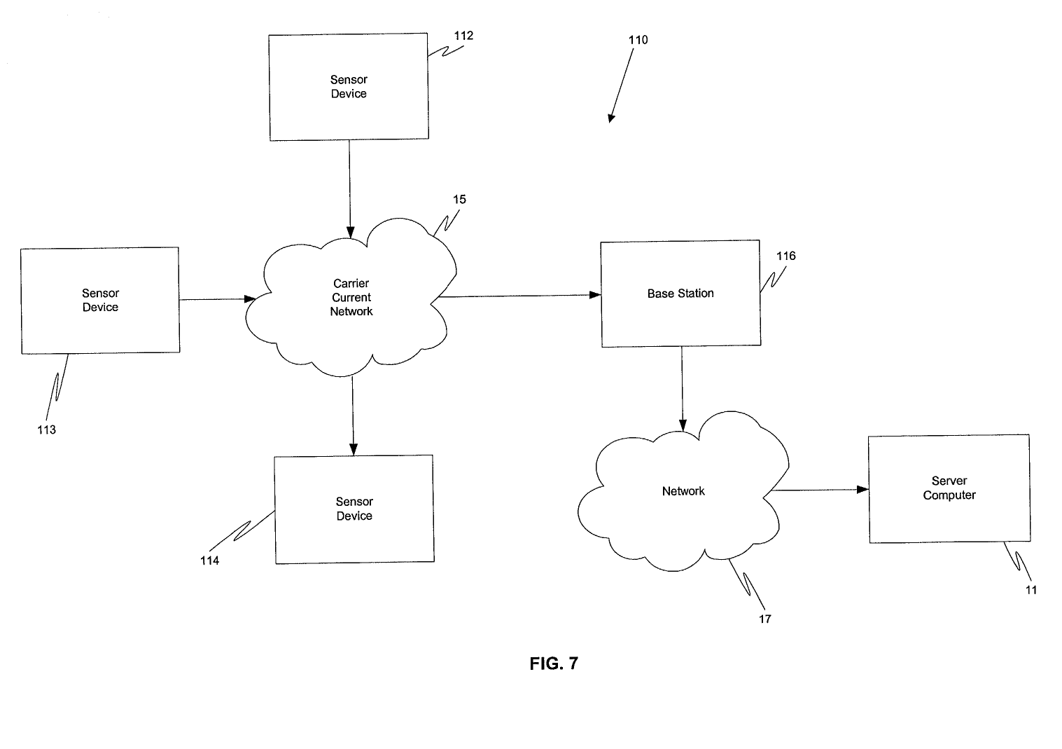

Turning to FIG. 7, another preferred embodiment of a telemetry system 110 is shown, in accordance with the present invention. Similar to the previous embodiment, the system 110 generally includes a base station 116 that is connected both to a local carrier media network 15 and to an electronic network 17. Unlike the previous embodiment, the system 110 includes a plurality of sensor devices 112, 113, 114 that are also connected to the local carrier media network 15. Each of the sensor devices 112, 113, 114 may include a sensor and/or a respective relay module (not shown), similar to the previous embodiment.

In this embodiment, when each of the sensor devices 112, 113, 114 generates sensor data, a sensor identifier is associated with the respective sensor data, thereby identifying from which of the sensor devices 112, 113, 114 the sensor data originated. In addition, other header data, e.g., date stamps, may also be associated with respective sensor data. The sensor devices 112, 113, 114 may generate a data signal representing the sensor data, associated sensor identifier, and other desired header data, and send a carrier media signal including the data signal carried by a carrier media.

When the base station 116 detects carrier media signals, a decoupler (not shown) may extract sensor identifiers and associated sensor data from the detected carrier media signals, thereby identifying which of the sensor devices 112, 113, 114 from which the associated sensor data originated. Thus, the base station 116 may be able to receive carrier media signals from multiple sensor devices and/or relay modules. This may be useful if multiple patients are being monitored, for example, in a hospital or other health care facility.

The sensor devices 112, 113, 114 may use pseudo-random codes, or other known mechanisms for identifying themselves, which the base station 116 may use to isolate and uniquely identify the respective sensor devices. This may be particularly useful if the sensor devices 112, 113, 114 send carrier media signals to the base station at the same time. The base station 116 may detect and extract sensor identifiers in the header data of the data signals, and ignore carrier media signals except for those from one or more sensor devices of particular interest.

In alternative embodiments, it may desirable to provide two-way communication between the sensor devices 112, 113, 114 and the base station 116. The base station 116 may include a coupler (either the same or different coupler than that used to detect signals) that is configured to send its own carrier media signals to the sensor devices 112, 113, 114. For example, as shown in FIG. 4, a base station 16 may also include a digital-to-analog converter 64 and/or a filter/switch/power amplifier 66 that may be coupled to a transceiver 54 and coupler 48 to facilitate transmission of commands to respective sensor devices.

Similarly, the sensor devices may include decouplers (either the same or different coupler than that used to send signals) for extracting commands received from the base station 116 via the local carrier media network 15. For example, as shown in FIG. 3, a relay module 14 may include a filter/input amplifier 68 and/or an analog-to-digital converter 70 coupled between a coupler 32 and a transceiver for receiving and extracting commands from the base station. A processor 36 in the relay module 36 may interpret the commands, control its own operation and/or control a sensor device (not shown) in response to the commands.

Returning to FIG. 7, the base station 116 may control one or more of the sensor devices 112, 113, 114 to acquire and/or send sensor data. In addition, the base station 116 may send a synchronization command to each of the sensor devices 112, 113, 114, e.g., to provide sequential transfer of data from the sensor devices 112, 113, 114 to the base station 116. The base station 116 may also communicate with the sensor devices 112, 113, 114 in order to calibrate the sensor device(s), to test sensor/relay systems, test communications systems, and/or perform other diagnostic functions.

In a further alternative, other methods may be used to transfer data from each of the sensor devices 112, 113, 114 to the base station 116, such as infrared or radio frequency (RF) transmissions, as will be appreciated by those skilled in the art.

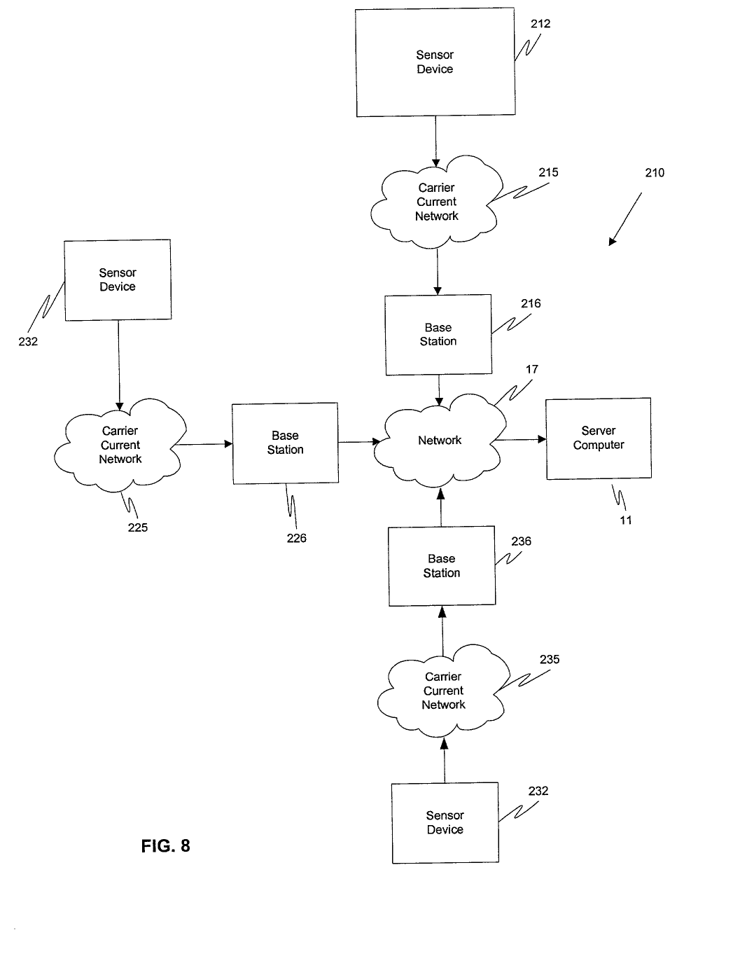

Turning to FIG. 8, another system 210 is shown for generating a patient database of sensor data, in accordance with the present invention. The system 210 generally includes a plurality of sets of sensor devices 212, 222, 232 located at respective locations, e.g., at respective individual patient's residences. Each sensor device 212, 222, 232 is configured for generating a carrier media signal including sensor data and a sensor identifier identifying the respective sensor device 212, 222, 232. Thus, each sensor device 212, 222, 232 may send carrier media signals over a respective carrier media network 215, 225, 235, e.g., using the local alternating current power lines at the respective patients' residences, similar to the embodiments described above.

Each set also includes a base station 216, 226, 236, connectable to the respective local carrier media network 215, 225, 235 and to an electronic network 17, such as the Internet, e.g., using a modem or other interface (not shown). Each base station 216, 226, 236 is configured for detecting carrier media signals from the respective sensor device and extracting the sensor identifier and associated sensor data from the detected carrier media signals, similar to that described above.

In addition, the system 210 includes a server computer 11 configured for communicating with the base stations 216, 226, 236 over the electronic network 17. The server computer 11 includes a patient database (not shown), including sensor data, e.g., physiological, behavioral, or other data acquired by the sensor devices 212, 222, 232. Sensor data associated with respective sensor devices 212, 222, 232 may be compiled into the patient database as it is received from the respective base stations 216, 226, 236. For example, the server computer 11 may extract the sensor identifiers from data submitted by respective base stations 216, 226, 236 and attribute the associated sensor data with a particular patient identified by the sensor data. Thus, the server computer 11 may compile data on each of the participating patients. A doctor or other health care professional may then easily monitor one or more of the patients or the server computer itself may monitor the database for predetermined conditions, as described above.

It will be appreciated by those skilled in the art that any number of sensor devices 212, 222, 232 may communicate with the server computer 11 via the network 17. In addition, a plurality of server computers (not shown) that may receive, store, and/or exchange sensor data received from the sensor devices 212, 222, 232, e.g., to share medical data with multiple health care professionals or institutions.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A system for transferring sensor data via an electronic network to a remote location, comprising:
a sensor device for generating sensor data related to a human subject;
a relay module operatively connected to the sensor device for receiving the sensor data from the sensor device, the relay module connectable to a local carrier media network, the relay module comprising a coupler for sending a carrier media signal over the local carrier media network, the carrier media signal comprising the sensor data; and
a base station connectable to the local carrier media network, the base station configured for detecting the carrier media signal from the relay module, the base station comprising a decoupler for extracting the sensor data from the carrier media signal, the base station further comprising an interface connectable to the electronic network, the interface configured for transferring the sensor data over the electronic network to a remote location.

2. The system of claim 1, wherein the sensor device and the relay module are contained within a single unit.

3. The system of claim 1, wherein the sensor device is intermittently connectable to the relay module.

4. The system of claim 1, wherein the sensor device and the relay module comprise a transmitter and receiver for wirelessly transmitting the sensor data from the sensor device to the relay module.

5. The system of claim 4, wherein the transmitter and receiver comprise a radio frequency (RF) transmitter and receiver or an infrared transmitter and receiver that utilize at least one of a single frequency and a spread spectrum signal.

6. The system of claim 1, wherein the sensor device comprises a sensor for detecting a physiological parameter of the human subject.

7. The system of claim 6, wherein the sensor is implanted within the human subject.

8. The system of claim 1, wherein the interface comprises a modem for transmitting data over a telecommunications network.

9. The system of claim 1, wherein the relay module comprises a processor for associating a sensor identifier with the sensor data, the sensor identifier identifying the sensor device, the carrier media signal further comprising the sensor identifier.

10. The system of claim 1, wherein the carrier media signal comprises an alternating current power supply signal which carries a relatively high frequency signal comprising the sensor data.

11. The system of claim 10, wherein the relatively high frequency signal comprises a radio frequency (RF) signal.

12. The system of claim 10, wherein the relatively high frequency signal comprises a spread spectrum signal.

13. A system for monitoring a patient, comprising:
a sensor device for monitoring a health-related parameter of a patient, the sensor device generating sensor data quantifying the health-related parameter;
a relay module for receiving sensor data from the sensor device, the relay module configured for generating a carrier media signal comprising the sensor data and a sensor identifier identifying the sensor device, the relay module comprising a coupler connectable to a local carrier media network for sending the carrier media signal over the local carrier media network; and
a base station connectable to the local carrier media network, the base station configured for detecting carrier media signals from one or more relay modules, the base station comprising a decoupler for extracting sensor identifiers and associated sensor data from detected carrier media signals.

14. The system of claim 13, wherein the base station further comprises memory for storing sensor identifiers and associated sensor data received from respective relay modules.

15. The system of claim 13, wherein the base station further comprises an interface connectable to an electronic network, the interface configured for communicating sensor data via the network to a remote location.

16. The system of claim 13, wherein the sensor device and the relay module comprise a transmitter and receiver for wirelessly transmitting the sensor data from the sensor device to the relay module.

17. The system of claim 16, wherein the transmitter and receiver comprise a radio frequency (RF) transmitter and receiver, or an infrared transmitter and receiver.

18. The system of claim 13, wherein the carrier media signal comprises an alternating current power supply signal which carries a relatively high frequency signal comprising the sensor data and the sensor identifier.

19. The system of claim 18, wherein the relatively high frequency signal comprises a radio frequency (RF) signal.

20. The system of claim 18, wherein the relatively high frequency signal comprises a spread spectrum signal.

21. A method for transferring sensor data from a sensor device to a remote location, the method comprising:
acquiring sensor data with the sensor device;
generating a carrier media signal, the carrier media signal comprising the sensor data;
sending the carrier media signal over a local carrier media network;
detecting the carrier media signal at a base station connected to the local carrier media network;
extracting the sensor data from the carrier media signal; and
transmitting the sensor data over an electronic network to the remote location.

22. The method of claim 21, further comprising sending the sensor data from the sensor device to a relay module, the relay module being connected to the local carrier media network.

23. The method of claim 22, wherein the relay module generates the carrier media signal and sends the carrier media signal over the local carrier media network.

24. The method of claim 22, wherein the sensor device and relay module comprise a transmitter and receiver for wirelessly sending the sensor data from the sensor device to the relay module.

25. The method of claim 24, wherein the transmitter and receiver comprise a radio frequency (RF) transmitter and receiver, or an infrared transmitter and receiver.

26. The method of claim 22, wherein the sensor device is connectable to the relay device by a cable.

27. The method of claim 21, wherein the acquiring step comprises activating the sensor device.

28. The method of claim 27, wherein the sensor device is user activated.

29. The method of claim 27, wherein the sensor device is automatically and periodically activated.

30. The method of claim 29, wherein the sensor device, when activated, automatically sends the sensor data to a relay module connected to the local carrier media network.

31. The method of claim 30, wherein the relay module stores the sensor data, and periodically sends a carrier media signal comprising the sensor data over the local carrier media network.

32. The method of claim 21, wherein the local carrier media network comprises alternating current power supply wiring.

33. The method of claim 32, wherein the carrier media signal comprises an alternating current power supply signal that carries a relatively high frequency signal comprising the sensor data.

34. The method of claim 33, wherein the relatively high frequency signal comprises a radio frequency (RF) signal.

35. The method of claim 33, wherein the relatively high frequency signal comprises a spread spectrum signal.

36. The method of claim 21, wherein the local carrier media network comprises local telephonic communications wiring.

37. A system for maintaining a database of patient medical data, comprising:
a plurality of sensor devices for monitoring health-related parameters of patients, each sensor device comprising:
a sensor for generating sensor data quantifying a health-related parameter;
a relay module for receiving sensor data from the sensor device, the relay modules configured for generating a carrier media signal comprising the sensor data and a sensor identifier identifying the sensor device, the relay module configured for sending a carrier media signal over a local carrier media network; and
a base station connectable to the local carrier media network, the base station configured for detecting the carrier media signal from the relay module and extracting the sensor identifier and associated sensor data from detected carrier media signal, the base station comprising an interface for communicating over an electronic network; and
a server computer configured for communicating with the base stations over the electronic network, the server computer comprising a patient database including sensor data associated with the sensor devices of respective base stations based upon the respective sensor identifiers.
